(19) United States
(12) Patent Application Publication
(10) Pub. No.: US 2023/0207964 A1
(43) Pub. Date: Jun. 29, 2023

(54) NONAQUEOUS ELECTROLYTE SECONDARY BATTERY SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventor: Takuji YAMAMOTO, Niihama-shi (JP)

(73) Assignee: Sumitomo Chemical Company, Limited, Tokyo (JP)

(21) Appl. No.: 18/146,055

(22) Filed: Dec. 23, 2022

(30) Foreign Application Priority Data
Dec. 28, 2021 (JP) 2021-214925

(51) Int. Cl. H01M 50/449; H01M 50/417; H01M 50/423

(52) U.S. Cl. CPC H01M 50/449; H01M 50/417; H01M 50/423

(57) ABSTRACT

Provided is a nonaqueous electrolyte secondary battery separator having an excellent withstand voltage property after repeated charge-discharge cycles. The nonaqueous electrolyte secondary battery separator includes a polyolefin porous film, and a heat-resistant porous layer that contains a heat-resistant resin and that is formed on one surface or both surfaces of the polyolefin porous film, the nonaqueous electrolyte secondary battery separator having an absolute value of a ratio of change in thickness between before and after a heat-shock cycle test in a range of not more than 1.4%.

This Nonprovisional application claims priority under 35 U.S.C. § 119 on Patent Application No. 2021-214925 filed in Japan on Dec. 28, 2021, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a member for the nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries, particularly lithium-ion secondary batteries, have a high energy density, and are therefore in wide use as batteries for devices such as personal computers, mobile telephones, and portable information terminals. Such nonaqueous electrolyte secondary batteries have recently been developed as on-vehicle batteries.

As one example of a method for evaluating a storage property of such a nonaqueous electrolyte secondary battery, known is a method in which, as disclosed in Patent Literature 1, whether liquid leakage occurs in a nonaqueous electrolyte secondary battery is checked after performing a heat-shock cycle test, in which cycles of the following first and second steps are repeated a certain number of times: a first step of storing the nonaqueous electrolyte secondary battery in a high-temperature environment for a certain period of time; and a second step of storing the nonaqueous electrolyte secondary battery in a low-temperature environment.

In addition, as one example of a separator for such a nonaqueous electrolyte secondary battery, known is a separator for batteries which is a laminated porous film including (i) a polyolefin porous base material and (ii) a porous layer which is provided on at least one surface of the polyolefin porous base material and which includes, as necessary constituent elements, an organic filler and a binder resin.

### CITATION LIST

### Patent Literature

### Patent Literature 1

Pamphlet of International Publication No. WO 2020/202744

### SUMMARY OF INVENTION

### Technical Problem

However, as disclosed in Patent Literature 1, the heat-shock cycle test is a test for evaluating performance of a nonaqueous electrolyte secondary battery, but not a test for evaluating a property of a separator for such a battery.

In addition, a conventional separator for batteries, which is a laminated porous film, has had a room for improvement of a withstand voltage property after repeated charge-discharge cycles.

### Solution to Problem

The present inventors found that it is possible to obtain, by examining a separator alone by the heat-shock cycle test which is typically not used for evaluating the property of the separator, a new parameter of “absolute value of a ratio of change in thickness” which correlates with a withstand voltage property of the separator after repeated charge-discharge cycles. As a result, the present inventors have arrived at the present invention.

An aspect of the present invention encompasses the following <1> to <6>.

<1> A nonaqueous electrolyte secondary battery separator including:
a polyolefin porous film; and
a heat-resistant porous layer formed on one surface or both surfaces of the polyolefin porous film,
the heat-resistant porous layer containing a heat-resistant resin,
the nonaqueous electrolyte secondary battery separator having an absolute value of a ratio of change in thickness between before and after a heat-shock cycle test in a range of not more than 1.40%,
the ratio of change in thickness being defined by Formula (1) below,

ratio of change in thickness (%)={(D₀−D₁)/D₀}×100 (1)
where D₀ is a thickness (μm) of the nonaqueous electrolyte secondary battery separator before the heat-shock cycle test, and D₁ is a thickness (μm) of the nonaqueous electrolyte secondary battery separator after the heat-shock cycle test,
the heat-shock cycle test being performed under conditions in which: a high temperature is 85° C.; a low temperature is −40° C.; a maintenance time of the high temperature is 30 minutes; a maintenance time of the low temperature is 30 minutes; a temperature transition time between the high temperature and the low temperature is one minute; and the number of cycles is 150 cycles.
   <2> The nonaqueous electrolyte secondary battery separator according to <1>, wherein the heat-resistant porous layer is formed on each of the both surfaces of the polyolefin porous film.
   <3> The nonaqueous electrolyte secondary battery separator according to <1> or <2>, wherein the heat-resistant resin is a nitrogen-containing aromatic resin.
   <4> The nonaqueous electrolyte secondary battery separator according to <3>, wherein the nitrogen-containing aromatic resin is an aramid resin.
   <5> A nonaqueous electrolyte secondary battery member including:
a positive electrode;
the nonaqueous electrolyte secondary battery separator according to any one of <1> to <4>; and
a negative electrode,
the positive electrode, the nonaqueous electrolyte secondary battery separator, and the negative electrode being disposed in this order.
   <6> A nonaqueous electrolyte secondary battery including the nonaqueous electrolyte secondary battery separator according to any one of <1> and <4>.

### Advantageous Effects of Invention

The nonaqueous electrolyte secondary battery separator in accordance with an embodiment of the present invention advantageously has an excellent withstand voltage property after repeated charge-discharge cycles.

### DESCRIPTION OF EMBODIMENTS

The following description will discuss an embodiment of the present invention. Note, however, that the present invention is not limited to the embodiment. The present invention is not limited to arrangements described below, but may be altered in various ways by a skilled person within the scope of the claims. The present invention also encompasses, in its technical scope, any embodiment derived by appropriately combining technical means disclosed in differing embodiments. Note that a numerical range “A to B” herein means “not less than A and not more than B” unless otherwise stated.

### Embodiment 1: Nonaqueous Electrolyte Secondary Battery Separator

A nonaqueous electrolyte secondary battery separator in accordance with Embodiment 1 of the present invention includes: a polyolefin porous film; and a heat-resistant porous layer formed on one surface or both surfaces of the polyolefin porous film, the heat-resistant porous layer containing a heat-resistant resin. The nonaqueous electrolyte secondary battery separator has an absolute value of a rate of change in thickness between before and after a heat-shock cycle test in a range of not more than 1.40%. The ratio of change in thickness is defined by Formula (1) below.

ratio of change in thickness (%)={(D₀−D₁)/D₀}×100 (1)

In Formula (1), D₀ is a thickness (μm) of the nonaqueous electrolyte secondary battery separator before the heat-shock cycle test, and D₁ is a thickness (μm) of the nonaqueous electrolyte secondary battery separator after the heat-shock cycle test. Here, the heat-shock cycle test is performed under a condition in which: a high temperature is 85° C.; a low temperature is −40° C.; a maintenance time of the high temperature is 30 minutes; a maintenance time of the low temperature is 30 minutes; a temperature transition time between the high temperature and the low temperature is one minute; and the number of cycles is 150 cycles.

The nonaqueous electrolyte secondary battery separator in accordance with an embodiment of the present invention includes a polyolefin porous film, a heat-resistant porous layer which is formed on one surface or both surfaces of the polyolefin porous film. Hereinafter, the “nonaqueous electrolyte secondary battery separator” may also be referred to simply as a “separator”, the polyolefin porous film may also be referred to simply as a “porous film”, and a heat-resistant porous layer may also be referred to simply as a “porous layer”.

The separator in accordance with an embodiment of the present invention has the absolute value of a ratio of change in thickness between before and after a heat-shock cycle test in a range of not more than 1.4%. The heat-shock cycle test is performed under conditions in which: a high temperature is 85° C.; a low temperature is −40° C.; a maintenance time of the high temperature is 30 minutes; a maintenance time of the low temperature is 30 minutes; a temperature transition time between the high temperature and the low temperature is one minute; and the number of cycles is 150 cycles. Hereinafter, the “ratio of change in thickness between before and after a heat-shock cycle test” may also be referred to simply as “ratio of change in thickness”. The absolute value of the ratio of change in thickness depends on a degree of change in structure of the separator between before and after the heat-shock cycle test. The heat-resistant porous layer of the separator has a high heat-resistant property, and has a smaller change in structure after repeated temperature changes than the porous film. Therefore, the absolute value of the ratio of change in thickness mainly depends on the degree of change in structure of the porous film constituting the separator between before and after the heat-shock cycle test.

Further, the separator in accordance with an embodiment of the present invention is provided with a heat-resistant porous layer which contains a heat-resistant resin and which is formed on one surface or both surfaces of the porous film. The heat-resistant resin permeates the surface of the porous film on which surface the heat-resistant porous layer has been formed. The heat-resistant resin, which has permeated, thus fixes a crystal orientation of polyolefin of the porous film near an interface between the porous film and the heat-resistant porous layer of the porous film. In addition, the heat-resistant resin, which has permeated, densifies a crystal structure of the porous film near the interface between the porous film and the heat-resistant porous layer of the porous film. Fixation of the orientation and densification of the crystal structure reduces the change in structure of the porous film after repeated temperature changes. Therefore, the absolute value of the ratio of change in thickness serves as a parameter for evaluating a degree of fixation of the orientation and a degree of densification of the crystal structure.

Here, in the nonaqueous electrolyte secondary battery, a positive electrode and a negative electrode expand and shrink when charge and discharge are repeated. In the nonaqueous electrolyte secondary battery, the separator is located between the positive electrode and the negative electrode. Thus, in a conventional nonaqueous electrolyte secondary battery provided with a separator that includes a porous film and a heat-resistant porous layer which is formed on the porous film, the expansion and shrinkage of the positive and negative electrodes exert external force on the separator. This peels off a portion of the heat-resistant porous layer from the separator. This may result in decrease of the withstand voltage property of the conventional separator.

In contrast, in the separator in accordance with an embodiment of the present invention, the absolute value of the ratio of change in thickness is as small as not more than 1.40%. Thus, in the separator in accordance with an embodiment of the present invention, the crystal orientation of the polyolefin of the porous film is suitably fixed near the interface between the porous film and the heat-resistant porous layer of the porous film, and the structure of the porous film is suitably densified near the interface between the porous film and the heat-resistant porous layer of the porous film. Therefore, in the separator in accordance with an embodiment of the present invention, the heat-resistant resin suitably permeates, and the withstand voltage property of the porous film itself is suitably improved. In light of this, even if a portion of the heat-resistant porous layer is peeled off, the separator in accordance with an embodiment of the present invention can retain a sufficient withstand voltage property. As a result, the separator in accordance with an embodiment of the present invention advantageously has an excellent withstand voltage property after repeated charge-discharge cycles.

In view of the above-described withstand voltage property after repeated charge-discharge cycles, the absolute value of the ratio of change in thickness is preferably small. Specifically, the absolute value of the ratio of change in thickness is preferably not more than 1.38%, and more preferably not more than 1.36%. In addition, the absolute value of the ratio of change in thickness is preferably not less than 0.10%, and more preferably not less than 0.15%.

In an embodiment of the present invention, the heat-shock cycle test is not particularly limited, provided that the following conditions are achieved: a high temperature is 85° C.; a low temperature is −40° C.; a maintenance time of the high temperature is 30 minutes; a maintenance time of the low temperature is 30 minutes; a temperature transition time between the high temperature and the low temperature is one minute; and the number of cycles is 150 cycles. For example, the heat-shock cycle test can be carried out with use of a commercially-available thermal shock testing device. Specific examples of the heat-shock cycle test include a heat-shock cycle test described in Examples. Further, the heat-shock cycle test is carried out preferably under a condition in which ambient air is not introduced and dew condensation is prevented.

Specifically, the heat-shock cycle test is carried out by, for example, the steps of (1) to (6) as follows:

(1) After the separator is put into a testing device, the testing device is hermetically closed and then an inside of the testing device is heated so as to reach 85° C.
(2) The testing device is left for 30 minutes while the temperature inside the testing device is maintained at 85° C.
(3) After step (2), the inside of the testing device is cooled so as to reach −40° C. in one minute.
(4) The testing device is left for 30 minutes while the temperature inside the testing device is maintained at −40° C.
(5) After step (4), the inside of the testing device is heated so as to reach 85° C. in one minute.
(6) Steps (2) to (5) are repeated so that the number of times of repetition (the number of cycles) becomes 150 cycles.

In the steps (1), (3), and (5), the above heating and cooling can be carried out through any method, and it is possible to employ a method which can be typically employed by a person skilled in the art.

### Polyolefin Porous Film

The porous film contains a polyolefin-based resin and is generally a porous film which is mainly made of the polyolefin-based resin. Note that the expression “mainly made of a polyolefin-based resin” means that the ratio of the polyolefin-based resin in the porous film with respect to all materials contained in the porous film is not less than 50% by weight, preferably not less than 90% by weight, and more preferably not less than 95% by weight.

The porous film has therein many pores connected to one another, so that a gas and a liquid can pass through the porous film from one surface to the other.

The porous film preferably has a thickness of 4 μm to 40 μm, and more preferably 5 μm to 20 μm. If the porous layer has a thickness of not less than 4 μm, it is possible to sufficiently prevent a short circuit in a battery. Meanwhile, if the porous film has a thickness of not more than 40 μm, it is possible to prevent increase in size of the nonaqueous electrolyte secondary battery.

The polyolefin-based resin preferably contains a high molecular weight component having a weight-average molecular weight of 5×10³ to 15×10⁶. In particular, the polyolefin-based resin more preferably contains a high molecular weight component having a weight-average molecular weight of not less than 1,000,000 because such a high molecular weight component improves the strength of a resultant porous film and the strength of a separator including the porous film.

The polyolefin-based resin is not particularly limited. Examples of the polyolefin-based resin include thermoplastic resins, each of which is a homopolymer or a copolymer that is obtained by polymerizing a monomer(s) such as ethylene, propylene, 1-butene, 4-methyl-1-pentene, 1-hexene, and/or the like. Examples of the homopolymer include polyethylene, polypropylene, and polybutene. Examples of the copolymer include an ethylene-propylene copolymer.

Among the above examples, polyethylene is more preferable as the polyolefin-based resin because use of polyethylene makes it possible to prevent a flow of excessively large current into the separator at a lower temperature. Note that preventing such a flow of excessively large electric current is also called “shutdown.” Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable as the polyethylene.

A weight per unit area of the porous film can be set as appropriate in view of the strength, thickness, weight, and handleability of the porous film. Note, however, that the weight per unit area of the porous film is preferably 4 g/m² to 20 g/m², more preferably 4 g/m² to 12 g/m², and still more preferably 5 g/m² to 10 g/m², so as to allow the nonaqueous electrolyte secondary battery to have a higher weight energy density and a higher volume energy density.

The porous film has an air permeability of preferably 30 sec/100 mL to 500 sec/100 mL, and more preferably 50 sec/100 mL to 300 sec/100 mL, in terms of Gurley values. A porous film having the above air permeability can achieve sufficient ion permeability.

The porous film has a porosity of preferably 20% by volume to 80% by volume, and more preferably 30% by volume to 75% by volume, so as to (i) retain an electrolyte in a larger amount and (ii) obtain a function of reliably preventing a flow of an excessively large electric current at a lower temperature. Further, in order to achieve sufficient ion permeability and prevent particles from entering the positive electrode and/or the negative electrode, the porous film has pores each having a pore size of preferably not more than 0.3 μm, and more preferably not more than 0.14 μm.

### Heat-Resistant Porous Layer

In an embodiment of the present invention, the heat-resistant porous layer is formed on one surface or both surfaces of the polyolefin porous film, and is preferably formed on each of both surfaces of the polyolefin porous film. The heat-resistant porous layer contains a heat-resistant resin. The heat-resistant porous layer is preferably an insulating porous layer.

If the porous layer is formed on one surface of the polyolefin porous film, the porous layer is preferably formed on a surface which is of the polyolefin film and which faces a positive electrode, and more preferably formed on a surface which is in contact with the positive electrode.

Examples of the heat-resistant resin of which the porous layer is made include polyolefins; (meth)acrylate-based resins; fluorine-containing resins; polyamide-based resins; polyimide-based resins;

polyester-based resins; rubbers; resins each having a melting point or a glass transition temperature of not less than 180° C.; and water-soluble polymers.

Among the above examples of the heat-resistant resin, polyolefins, polyester-based resins, acrylate-based resins, fluorine-containing resins, polyamide-based resins, and water-soluble polymers are preferable. Of the polyamide-based resins, wholly aromatic polyamides (aramid resins) are preferable. Of the polyester-based resins, polyarylates and liquid crystal polyesters are preferable. Of the fluorine-containing resins, polyvinylidene fluoride-based resins are preferable.

In addition, the heat-resistant resin is preferably a nitrogen-containing aromatic resin. As the nitrogen-containing aromatic resin, an aramid resin is more preferable. Examples of the aramid resin include para-aramid and meta-aramid. Among these, the para-aramid is still more preferable as the aramid resin. Examples of the para-aramid encompass para-aramids each having a para-oriented structure or a quasi-para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), a paraphenylene terephthalamide/2,6-dichloroparaphenylene terephthalamide copolymer, poly(4,4′-diphenylsulfonyl terephthalamide), and a paraphenylene terephthalamide/4,4-diphenylsulfonyl terephthalamide copolymer.

The porous layer can contain a filler. The filler may be an inorganic filler or an organic filler. The filler is more preferably an inorganic filler made of an inorganic oxide such as silica, calcium oxide, magnesium oxide, titanium oxide, alumina, mica, zeolite, aluminum hydroxide, or boehmite. An amount of filler contained in the porous layer may be 10% by weight to 99% by weight, and may be 20% by weight to 75% by weight, with respect to a total amount of the resin and the filler.

In particular, if the heat-resistant resin used for the porous layer is an aramid resin, controlling the amount of filler contained so as to fall in the above-described range of 20% by weight to 75% by weight makes it possible to control an increase in the weight of the separator due to the filler, and also makes it possible to obtain a separator having favorable ion permeability.

In Embodiment 1 of the present invention, the porous layer is preferably provided between the polyolefin porous film and a positive electrode active material layer of the positive electrode. The descriptions below of the physical properties of the porous layer describe at least the physical properties of a porous layer disposed between the polyolefin porous film and the positive electrode active material layer of the positive electrode in a nonaqueous electrolyte secondary battery.

The porous layer has an average thickness of preferably 0.5 μm to 10 μm per layer (per porous layer), and more preferably 1 μm to 5 μm per layer (per porous layer) in order to ensure adhesion of the porous layer to an electrode and a high energy density. The porous layer having a thickness of not less than 0.5 μm per layer makes it possible to sufficiently prevent an internal short circuit caused by, for example, damage to the nonaqueous electrolyte secondary battery, and also to retain a sufficient amount of the electrolyte in the porous layer. If the thickness of the porous layer is greater than 10 μm per layer, resistance to lithium ion permeation increases in the nonaqueous electrolyte secondary battery. This can cause the positive electrode to deteriorate along with repeated cycles. As a result, the nonaqueous electrolyte secondary battery may suffer a deterioration in a rate characteristic and cycle characteristic. If the thickness of the porous layer is greater than 10 μm per layer, the distance between the positive electrode and the negative electrode is increased. This can lead to a decreased internal volume efficiency of the nonaqueous electrolyte secondary battery.

A weight per unit area of the porous layer can be set as appropriate in view of the strength, thickness, weight, and handleability of the porous layer. The weight per unit area of the porous layer is preferably 0.5 g/m² to 20 g/m² per layer (per porous layer) and more preferably 0.5 g/m² to 10 g/m² per layer (per porous layer). A porous layer having a weight per unit area within the above numerical range allows a nonaqueous electrolyte secondary battery including the porous layer to have a higher weight energy density and a higher volume energy density. A porous layer whose weight per unit area exceeds the above range tends to cause a nonaqueous electrolyte secondary battery to be heavy.

The porous layer has a porosity of preferably 20% by volume to 90% by volume, and more preferably 30% by volume to 80% by volume, in order to achieve sufficient ion permeability. The pores in the porous layer have a diameter of preferably not more than 1.0 μm, and more preferably not more than 0.5 μm. When the pores each have such a diameter, a nonaqueous electrolyte secondary battery that includes the porous layer can achieve sufficient ion permeability.

A laminated separator including the porous film and the porous layer formed on the porous film has an air permeability of preferably 30 sec/100 mL to 1000 sec/100 mL, and more preferably 50 sec/100 mL to 800 sec/100 mL, in terms of Gurley values. In the nonaqueous electrolyte secondary battery, the laminated separator which has an air permeability falling within the above range can achieve sufficient ion permeability.

### Physical Properties of Nonaqueous Electrolyte Secondary Battery Separator

The separator in accordance with an embodiment of the present invention has a thickness of preferably 5.5 μm to 45 μm, and more preferably 6 μm to 25 μm.

The separator has an air permeability of preferably 100 sec/100mL to 350 sec/100mL, and more preferably 100 sec/100mL to 300 sec/100mL in terms of Gurley values.

A weight per unit area of the separator is preferably 3.0 g/m² to 13.0 g/m², and more preferably 5.0 g/m² to 9.0 g/m². The separator having a weight per unit area falling within the above numerical range allows a nonaqueous electrolyte secondary battery including the separator to have a higher weight energy density and a higher volume energy density.

The separator in accordance with an embodiment of the present invention may include, as necessary, another porous layer other than the porous film and the porous layer, provided that the other porous layer does not prevent attainment of an object of an embodiment of the present invention. Examples of the other porous layer encompass publicly known porous layers such as a heat-resistant layer, an adhesive layer, and a protective layer.

### Method for Producing Nonaqueous Electrolyte Secondary Battery Separator

### Method for Producing Polyolefin Porous Film

A method for producing the porous film is not particularly limited. For example, the polyolefin porous film can be produced by a method as follows. First, polyolefin-based resin is kneaded together with a pore forming agent such as an inorganic bulking agent or a plasticizer, and optionally with another agent(s) such as an antioxidant. After kneading, the kneaded substances are extruded so as to produce a polyolefin resin composition in sheet form. The pore forming agent is then removed from the polyolefin resin composition in sheet form with use of a suitable solvent. After the pore forming agent is removed, the polyolefin resin composition is stretched so that a polyolefin porous film is obtained.

The inorganic bulking agent is not particularly limited. Examples of the inorganic bulking agent include inorganic fillers; one specific example is calcium carbonate. The plasticizer is not particularly limited. Examples of the plasticizer include a low molecular weight hydrocarbon such as liquid paraffin.

As a more specific example of a method for producing the porous film, a method including the following steps may be used.

(A) Obtaining a polyolefin resin composition by kneading ultra-high molecular weight polyethylene, low molecular weight polyethylene having a weight-average molecular weight of not more than 10,000, a pore forming agent such as calcium carbonate or a plasticizer, and an antioxidant;
(B) Forming a sheet by (i) rolling the polyolefin resin composition with use of a pair of rollers for rolling and (ii) cooling the polyolefin resin composition in stages while tensioning the polyolefin resin composition with use of a take-up roller whose velocity ratio differs from that of the rollers for rolling;
(C) Removing the pore forming agent from the sheet with use of a suitable solvent; and
(D) Stretching the sheet, from which the pore forming agent has been removed, with use of a suitable stretch ratio.

### Method for Producing Porous Layer and Laminated Separator

Examples of a method for producing the porous layer in accordance with an embodiment of the present invention and the laminated separator in accordance with an embodiment of the present invention include: a method including the steps of (i) forming a coating layer by applying a coating solution, which contains a resin to be contained in the porous layer, to one surface or both surfaces of the porous film and (ii) removing a solvent by drying the porous film, so that the porous layer is formed on the porous film; and a method including the steps of (i) applying a coating solution, which contains a resin to be contained in the porous layer, to one surface or both surfaces of the porous film, (ii) forming a coating layer by depositing the resin to be contained in the porous layer onto the porous film under conditions of a certain temperature and a certain relative humidity and then (iii) removing the solvent by drying, so that the porous layer is formed on the porous film.

Note that, if the porous layer is formed on both surfaces of the porous film, (a) the porous layer may be formed on the both surfaces of the porous film in parallel, or (b) the coating solution may be applied to one surface of the porous film and the porous layer may be formed on the one surface of the porous film after the coating solution has been applied to the other surface of the porous film and the porous layer has been formed on the other surface of the porous film.

In addition, before applying the coating solution to one surface or both surfaces of the porous film, a hydrophilization treatment can be carried out as necessary with respect to the one surface or both surfaces which is/are a surface(s) of the polyolefin porous film and to which the coating solution is to be applied.

The coating solution contains the heat-resistant resin to be contained in the porous layer. In addition, the coating solution can contain fine particles (described later) which can be contained in the porous layer. The coating solution can be prepared typically by dissolving, in a solvent, the heat-resistant resin that can be contained in the porous layer and dispersing the fine particles. The solvent in which the heat-resistant resin is to be dissolved also serves as a dispersion medium in which the fine particles are to be dispersed. Alternatively, depending on the solvent, the heat-resistant resin may be an emulsion.

The solvent is not particularly limited, provided that (i) the solvent does not have an adverse effect on the polyolefin porous film, (ii) the solvent allows the heat-resistant resin to be uniformly and stably dissolved in the solvent, and (iii) the solvent allows the fine particles to be uniformly and stably dispersed in the solvent. Specific examples of the solvent encompass water and organic solvents. Each of the solvents can be used solely. Alternatively, two or more of the solvents can be used in combination.

The coating solution can be formed by any method, provided that it is possible for the coating solution to meet conditions (such as a resin solid content (resin concentration) and a fine particle amount) which are necessary to obtain a desired porous layer. Specific examples of a method for forming the coating solution include a mechanical stirring method, an ultrasonic dispersion method, a high-pressure dispersion method, and a media dispersion method. Note that the coating solution can contain, as a component other than the heat-resistant resin and the fine particles, an additive such as a disperser, a plasticizer, a surfactant, and a pH adjustor, provided that the additive does not prevent the object of the present invention from being attained. Note that the additive can be contained in an amount that does not prevent the object of the present invention from being attained.

A method for applying the coating solution to the porous film, that is, a method for forming the porous layer on the surface of the porous film is not particularly limited. Examples of the method for forming the porous layer include: a method in which the coating solution is applied directly to the surface of the porous film, so that a coating layer is formed and then the solvent is removed; a method in which (i) the coating solution is applied to an appropriate support to form a coating layer, (ii) the solvent is removed so that the porous layer is formed, (iii) the porous layer is pressure-bonded to the porous film, and then (iv) the support is peeled off; and a method in which (i) the coating solution is applied to an appropriate support to form a coating layer, (ii) the porous film is pressure-bonded to the coating layer, (iii) the support is peeled off, and then (iv) the solvent is removed.

The coating solution can be applied to the porous film or the support by a conventionally publicly known method. Specific examples of such a method include a gravure coater method, a dip coater method, a bar coater method, and a die coater method.

The solvent is typically removed by drying. The drying can also be carried out after the solvent contained in the coating solution is replaced with another solvent.

### Method for Controlling “Absolute Value of Ratio of Change in Thickness between before and after Heat-Shock Cycle Test

In an embodiment of the present invention, the following will discuss a method for controlling the “absolute value of the ratio of change in thickness between before and after a heat-shock cycle test” so that the absolute value of the ratio falls within a suitable range. Examples of such a method include a method in which a degree of permeation of the heat-resistant resin, of which the heat-resistant porous layer is made, into the porous film is suitably controlled by the following method (a) and/or method (b).

Method (a): a tension applied to the porous film is controlled so as to fall within a suitable range, (i) after a coating solution is applied to the porous film, so that a coating layer is formed, and (ii) before the solvent contained in the coating layer is removed by drying, so that the porous layer is formed.

Method (b): (i) the coating solution is applied onto the porous film, so that a coating layer is formed, (ii) the solvent is removed, and then (iii) a heat treatment (annealing) is carried out at a suitable temperature with respect to the coating layer.

With regard to the step of forming the porous layer by drying so as to remove the solvent from the coating layer after forming the coating layer on the porous film by applying the coating solution to the porous film, typically, the step is carried out while a certain tension is being applied to the porous film. In the method (a), specifically, the tension which is applied to the porous film before drying the coating layer is configured to be smaller than a tension which is applied to a porous film before drying a coating layer in the conventional method for forming a porous layer. The tension thus reduced causes a gap (room) which the heat-resistant resin contained in the coating layer can permeate to be generated in a structure near the surface which is of the porous film and on which the coating layer has been formed. The method (a), thus, allows the heat-resistant resin to easily permeate the porous film. This consequently allows, near the both surfaces of the porous film, a crystal orientation of the polyolefin to be further fixed and a crystal structure of the polyolefin to be further densified. Therefore, the absolute value of the ratio of change in thickness can be reduced, so that the absolute value can be controlled so as to fall within a suitable range of not more than 1.40%. In order to reduce the absolute value of the ratio of change in thickness so that the absolute value is controlled so as to fall within a suitable range, the tension which is applied to the porous film before drying the coating layer is preferably not more than 0.120 N/mm, and more preferably not more than 0.110 N/mm. Specifically, when the porous layer is formed, preferably, a tension shown in a “water cleaning MID” column in Table 2 in Examples described later is controlled, as the tension which is applied to the porous film before drying the coating layer, so as to fall within the above-described preferable range. More preferably, both of the tension shown in the “water cleaning MID” column and a tension shown in a “water cleaning OUT” column in Table 2 in Examples described later are controlled, as tensions which are applied to the porous film before drying the coating layer, so as to fall within the above-described preferable range.

In addition, in order to prevent a wrinkle and the like from being generated on the porous film, the tension which is applied to the porous film before drying the coating layer is preferably not less than 0.080 N/mm, and more preferably not less than 0.090 N/mm.

In the method (b), the heat treatment is a step in which after the drying treatment for removing the solvent contained in the coating layer, the coating layer is heated. This step is separate from the drying treatment. The heat treatment makes it possible to suitably control the crystal orientation and the densification of the crystal structure in a region of the porous film near an interface between the porous layer to be formed and the porous film. Thus, the absolute value of the ratio of change in thickness can be reduced, so that the absolute value can be controlled so as to fall within the suitable range of not more than 1.40%.

If, in addition to employing the method (a) and/or the method (b), for example, the porous layer is formed on each of both surfaces of the porous film, it is possible to further reduce the absolute value of the ratio of change in thickness, so that the absolute value can be controlled so as to fall within a more suitable range. Specifically, when the porous layer is formed on each of both surfaces of the porous film, the heat-resistant resin permeates both surfaces of the porous film. This can consequently allow, near both surfaces of the porous film, the crystal orientation of the polyolefin to be further fixed and the crystal structure of the polyolefin to be further densified. Therefore, the absolute value of the ratio of change in thickness can be controlled so as to fall within a more suitable range by, in addition to employing the method (a) and/or (b), forming the porous layer on each of both surfaces of the porous film.

### 2. Nonaqueous Electrolyte Secondary Battery Member and Nonaqueous Electrolyte Secondary Battery

A nonaqueous electrolyte secondary battery member in accordance with an embodiment of the present invention includes a positive electrode, the above-described separator or the above-described laminated separator, and a negative electrode, the positive electrode, the separator or the laminated separator, and the negative electrode being disposed in this order. In addition, a nonaqueous electrolyte secondary battery in accordance with an embodiment of the present invention includes the above-described separator or the above-described laminated separator.

The nonaqueous electrolyte secondary battery member in accordance with an embodiment of the present invention includes a separator having an excellent withstand voltage property after repeated charge-discharge cycles. This advantageously makes it possible to prevent self-discharge and local degradation in materials and to improve battery reliability, such as storage stability of the nonaqueous electrolyte secondary battery. The nonaqueous electrolyte secondary battery in accordance with an embodiment of the present invention advantageously has an excellent battery reliability by including the separator having an excellent withstand voltage property after repeated charge-discharge cycles.

As a method for producing the nonaqueous electrolyte secondary battery in accordance with an embodiment of the present invention, a publicly known method can be employed. For example, the nonaqueous electrolyte secondary battery member is formed by disposing a positive electrode, a polyolefin porous film, and a negative electrode in this order. Here, the porous layer can be present between the polyolefin porous film and the positive electrode and/or between the polyolefin porous film and the negative electrode. Subsequently, the nonaqueous electrolyte secondary battery member is put into a container which serves as a housing for the nonaqueous electrolyte secondary battery. After the container is filled with a nonaqueous electrolyte, the container is hermetically closed while pressure inside the container is reduced. In this way, the nonaqueous electrolyte secondary battery in accordance with an embodiment of the present invention can be produced.

### Positive Electrode

The positive electrode employed in an embodiment of the present invention is not limited to any particular one, provided that the positive electrode is one that is generally used as a positive electrode of a nonaqueous electrolyte secondary battery. Examples of the positive electrode include a positive electrode sheet having a structure in which an active material layer, containing a positive electrode active material and a binding agent, is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include lithium complex oxides each containing at least one selected from the group consisting of transition metals such as V, Mn, Fe, Co, and Ni.

Examples of the electrically conductive agent include carbonaceous materials such as natural graphite, artificial graphite, cokes, carbon black, pyrolytic carbons, carbon fiber, and a fired product of an organic polymer compound. Each of these electrically conductive agents can be used solely. Alternatively, two or more of these electrically conductive agents can be used in combination.

Examples of the binding agent include: fluorine-based resins such as polyvinylidene fluoride (PVDF); acrylic resin; and styrene butadiene rubber. Note that the binding agent serves also as a thickener.

Examples of the positive electrode current collector include electric conductors such as Al, Ni, and stainless steel. Of these electric conductors, Al is more preferable as the positive electrode current collector because Al is easily processed into a thin film and is inexpensive.

Examples of a method for producing the positive electrode sheet include: a method in which the positive electrode active material, the electrically conductive agent, and the binding agent are pressure-molded on the positive electrode current collector; and a method in which (i) the positive electrode active material, the electrically conductive agent, and the binding agent are formed into a paste with use of an appropriate organic solvent, (ii) the positive electrode current collector is coated with the paste, and (iii) the paste is dried and then pressured so that the paste is firmly fixed to the positive electrode current collector.

### Negative Electrode

The negative electrode employed in an embodiment of the present invention is not limited to any particular one, provided that the negative electrode is one that is generally used as a negative electrode of a nonaqueous electrolyte secondary battery. Examples of the negative electrode include a negative electrode sheet having a structure in which an active material layer, containing a negative electrode active material and a binding agent, is formed on a negative electrode current collector. The active material layer may further contain an electrically conductive agent.

Examples of the negative electrode active material include materials each capable of being doped with and dedoped of metal ions such as lithium ions or sodium ions. Examples of the materials include carbonaceous materials. Examples of the carbonaceous materials include natural graphite, artificial graphite, cokes, carbon black, and pyrolytic carbons.

Examples of the negative electrode current collector include Cu, Ni, and stainless steel. Of these materials, Cu is more preferable as the negative electrode current collector because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressured so that the paste is firmly fixed to the negative electrode current collector. The paste preferably contains an electrically conductive agent as described above and a binding agent as described above.

### Nonaqueous Electrolyte

A nonaqueous electrolyte for an embodiment of the present invention is not limited to any particular one, provided that the nonaqueous electrolyte is one that is generally used for a nonaqueous electrolyte secondary battery. The nonaqueous electrolyte can be, for example, a nonaqueous electrolyte containing an organic solvent and a lithium salt dissolved therein. Examples of the lithium salt encompass LiClO₄, LiPF₆, LiAsF₆, LiSbF₆, LiBF₄, LiCF₃SO₃, LiN(CF3SO₂)₂, LiC(CF₃SO₂)₃, Li₂B₁₀Cl₁₀, lower aliphatic carboxylic acid lithium salt, and LiAlCl₄. Each of these lithium salts can be used solely. Alternatively, two or more of these lithium salts can be used in combination.

Examples of the organic solvent to be contained in the nonaqueous electrolyte include carbonates, ethers, esters, nitriles, amides, carbamates, sulfur-containing compounds, and fluorine-containing organic solvents each obtained by introducing a fluorine group into any of these organic solvents. Each of these organic solvents can be used solely. Alternatively, two or more of these organic solvents can be used in combination.

### Examples

The present invention will be described below in more detail with reference to Examples and Comparative Examples. Note, however, that the present invention is not limited to such Examples.

### Measurement Methods

Each value in Examples and Comparative Examples was measured through the methods as follows.

### Measurement of Thickness

In each of Examples and Comparative Examples which will be described later, respective thicknesses of a porous film and a separator were measured with use of a high-precision digital measuring device (VL-50) manufactured by Mitutoyo Corporation. In addition, the difference between the thicknesses of the separator and the porous film was calculated and was regarded as a total thickness of a porous layer(s).

### Measurement of Weight per Unit Area

From the porous film in each of Examples and Comparative Examples which will be described later, a square having a side of 8 cm was cut out as a sample, and the weight W₁ (g) of the sample was measured. Then, a weight per unit area of the porous film was calculated by Formula (2) below.

Weight per unit area of porous film (g/m²)=W₁/(0.08×0.08) (2)

Similarly, from the separator in each of Examples and Comparative Examples which will be described later, a square having a side of 8 cm was cut out as a sample, and the weight W₂ (g) of the sample was measured. Then, a weight per unit area of the separator was calculated by Formula (3) below.

Weight per unit area of separator (g/m²)=W₂/(0.08×0.08) (3)

Further, the difference between the weights per unit area of the separator and the porous film was calculated and was regarded as a total weight per unit area of the porous layer(s).

### Measurement of Air Permeability

The air permeability (in terms of Gurley values) of the separator in each of Examples and Comparative Examples which will be described later was measured in conformity to JIS P8117.

### Measurement of Absolute Value of Ratio of Change in Thickness between before and after Heat-Shock Cycle Test

### Heat-Shock Cycle Test

A test sample was prepared by bonding, to a glass plate (manufactured by Nippon Sheet Glass Co., Ltd.; product name “Ultra Fine Flat Glass (FL110-L4)”; having a thickness of 1.1 mm), a laminated body that had been obtained by sandwiching the separator in each of Examples and Comparative Examples (described later) by two pieces of paper (produced by ASUKUL CORP.; product name “Multipaper Super White J”; having a thickness of 0.09 mm). The test sample was put into a thermal shock testing device (available from ESPEC CORP.; product name “TSA-71L-A-3”), and a heat-shock cycle test (hereinafter, also referred to as “HS test”) was carried out under the conditions as follows.
High temperature: 85° C.
Maintenance time of high temperature: 30 minutes
Low temperature: −40° C.
Maintenance time of low temperature: 30 minutes
Temperature transition time between high temperature and low temperature: one minute
Number of cycles, each of which was a temperature change cycle of high temperature—low temperature—high temperature: 150 cycles.

Note that in a condition that was set for the HS test, ambient air was not introduced and dew condensation was prevented.

### Measurement of Ratio of Change in Thickness

The thickness D₀ of the separator before the HS test and the thickness D₁ of the separator after the HS test were measured with use of the high-precision digital measuring device manufactured by Mitutoyo Corporation. With use of resultant thicknesses of the separator before and after the HS test, a ratio of change in the thickness between before and after the HS test was calculated by Formula (1) below, and the absolute value of the ratio of change was obtained.

Ratio of change in thickness (%)={(D₀−D₁)/D₀}×100 (1)

### Measurement of Withstand Voltage Limit after Peeling of Porous Layer(s)

The separator in each of Examples and Comparative Examples (described later) was subjected once to an operation in which the porous layer(s) of the separator was/were peeled off with use of a tape (manufactured by 3M; product name “Scotch Transparent Book Tape (thick type) 845”). The separator thus prepared was used as a sample. The sample was subjected to measurement of a withstand voltage limit. This measurement was carried out with use of an impulse insulation tester IMP3800K manufactured by Nippon Technart Inc. through the following procedure.

(i) Insert the sample as a measurement target between cylinder electrodes having a diameter of ϕ25 mm and a diameter of ϕ75 mm in the impulse insulation tester.
(ii) Electric charge was accumulated in a capacitor inside the impulse insulation tester to apply a voltage to the sample between those upper and lower cylindrical electrodes that were electrically connected to the inside capacitor. The voltage was set to be 0 V at the start of the measurement and then was increased linearly, that is, at a constant rate (25 V/sec).
(iii) Until a dielectric breakdown occurred, that is, until a voltage drop was detected, the voltage was continually applied and the voltage at which the voltage drop was detected was measured. The voltage thus measured was regarded as the withstand voltage limit of the separator whose porous layer(s) had been peeled off.

### Example 1

### Preparation of Coating Solution

As a resin of which the porous layer was made, poly(paraphenylene terephthalamide) (hereinafter, referred to as “PPTA”), which is one kind of aramid resins, was synthesized through the following method.

As a vessel for synthesis, a separable flask which had a capacity of 3 L was used. The flask had a stirring blade, a thermometer, a nitrogen incurrent tube, and a powder addition port. Into the flask which had been sufficiently dried, 2200 g of N-methyl-2-pyrrolidone (NMP) was introduced. Then, 151.07 g of a calcium chloride powder was added to the NMP. Then, a resultant mixture was heated so as to reach 100° C. and the calcium chloride powder was completely dissolved, so that an NMP solution of calcium chloride was obtained. The above calcium chloride powder had been vacuum-dried in advance for two hours at a temperature of 200° C.

Subsequently, the temperature of the NMP solution of calcium chloride was cooled down to room temperature. Then, 68.23 g of paraphenylenediamine was added to the NMP solution of calcium chloride and was completely dissolved, so that a solution (1) was obtained. While the temperature of the solution (1) was maintained at 20° C.±2° C., 124.25 g of terephthalic acid dichloride was added to the solution (1) in four separate portions at intervals of approximately 10 minutes. Thereafter, while the solution (1) was stirred at 150 rpm, the solution (1) was matured for one hour in a state in which the temperature was maintained at 20° C.±2° C. As a result, an aramid polymerization liquid (1) containing 6% by weight of PPTA was obtained. The PPTA contained in the aramid polymerization liquid (1) had an intrinsic viscosity of 1.5 g/dL.

Then, 100 g of the aramid polymerization liquid (1) was weighed out and put into another flask. Further, 6.0 g of alumina A (average particle diameter: 13 nm) was added into the another flask, so that a mixed liquid A(1) was obtained. In the mixed liquid A(1), the weight ratio of PPTA and alumina A was 1:1. Subsequently, NMP was added to the mixed liquid A(1) so that the mixed liquid A(1) had a solid content of 4.5% by weight. Then, the mixed liquid A(1) was stirred for 240 minutes, so that a mixed liquid B(1) was obtained. Here, the “solid content” refers to a total weight of the PPTA and the alumina A. Further, to the mixed liquid B(1), 0.73 g of calcium carbonate was added and a resultant solution was stirred for 240 minutes to be neutralized. As a result, a neutralization liquid (1) was obtained. Thereafter, the neutralization liquid (1) was defoamed under a reduced pressure, so that a coating solution (1) in the form of slurry was prepared.

### Preparation of Nonaqueous Electrolyte Secondary Battery Separator

While a polyethylene porous film (hereinafter, also referred to simply as “porous film”) was being transferred, first continuous coating of the coating solution (1) in the form of slurry was performed with respect to one surface of the porous film, so that a coating film was formed. Table 1 below shows the thickness and weight per unit area of the porous film.

Subsequently, while the porous film on which the coating film had been formed was being transferred, PPTA was deposited on the porous film under conditions of a temperature shown in Table 2 below and of a relative humidity of 75%. Subsequently, the coating film in which the PPTA had been deposited was subjected to a water cleaning step in which the coating film was cleaned with water, so that the calcium chloride and the solvent were removed. In the water cleaning step, the porous film on which the coating film had been formed was caused to pass through a plurality of water-cleaning tanks, each of which was filled with water, so that water cleaning was carried out. Here, a feed roller was provided in each space between adjacent water-cleaning tanks, and a rotation speed of the feed roller was increased until a tension applied to the porous film reached a predetermined value. With this method, the tension was controlled so as to be a magnitude shown in the “Water cleaning MID” column in Table 2. In addition, another feed roller was provided just after the last water-cleaning tank, and a rotation speed of this feed roller was controlled. With this control, a tension applied to the porous film at the end of the water cleaning step was controlled so as to be a magnitude shown in the “Water cleaning OUT” column in Table 2.

Subsequently, with respect to the coating film from which the calcium chloride and the solvent had been removed, a drying treatment was performed with use of a heating roller group 1 at a heating temperature R₁ shown in Table 2 below, and then another drying treatment was performed with use of a heating roller group 2 at a heating temperature R₂ shown in Table 2 below. That is, a first drying treatment was performed in which the coating film was consecutively dried. As a result, a single-sided laminated separator (1) was obtained in which the porous layer was formed on one surface of the porous film. It should be noted that upstream half of rollers in the heating roller group 2 had a temperature which differed from downstream half of the rollers in the heating roller group 2. Hereinafter, it is assumed that the heating temperature of the upstream half of the rollers is Rea, and the heating temperature of the downstream half of the rollers is R_{2b}. Note that the “upstream half of the rollers” refers to rollers located on an upstream side of the heating roller group 2, and the “downstream half of the rollers” refers to the remaining rollers located on a downstream side of the heating roller group 2. In other words, the coating film was dried by being subjected to a drying treatment in which drying at the heating temperature R₁ was followed by drying at the heating temperature R₂ₐ and further by drying at the heating temperature R_{2b}. Here, the drying at the heating temperature R₁ and the drying at the heating temperature R₂ₐ correspond to the step of removing the solvent from the coating film, and the drying at the heating temperature R_{2b} corresponds to the step of performing the heat treatment. That is, the porous layer was deposited on the porous film by the drying at the heating temperature R₂ₐ, and the porous film on which the porous layer had been deposited was heat-treated by the drying at the heating temperature R_{2b}.

Next, second continuous coating of the coating solution (1) in the form of slurry was performed with respect to an opposite surface to the above-described coated surface of the single-sided laminated separator. Subsequently, under the same conditions as those in production of the single-sided laminated separator, a coating film on which PPTA had been deposited was formed on the opposite surface, and the coating film in which the PPTA had been deposited was cleaned with water, so that the calcium chloride and the solvent were removed. With respect to the coating film from which the calcium chloride and the solvent had been removed, a second drying treatment was performed under the same conditions as those in the production of the single-sided laminated separator. As a result, a both-sided laminated separator (1) was obtained in which the porous layer was formed on each of both surfaces of the porous film. The both-sided laminated separator (1) was regarded as a separator (1).

### Example 2

A double-sided laminated separator (2) was obtained in the same manner as Example 1 except that the porous film was changed to a porous film having a thickness and a weight per unit area shown in Table 1 below, and that the conditions under which the PPTA was deposited and under which the water cleaning step and the drying treatment were performed were changed so as to match conditions shown in Table 2 blow. The double-sided laminated separator (2) was regarded as a separator (2).

### Example 3

A single-sided laminated separator (3) was obtained in the same manner as Example 1 except that the conditions under which the PPTA was deposited and under which the water cleaning step and the drying treatment were performed were changed so as to match the conditions shown in Table 2 below. In Example 3, the porous layer was formed on only one surface of the porous film, that is, steps of the second continuous coating to the second drying treatment were not performed. The single-sided laminated separator (3) was regarded as a separator (3).

### Example 4

A single-sided laminated separator (4) was obtained in the same manner as Example 1 except that (i) the porous film was changed to a porous film having a thickness and a weight per unit area shown in Table 1 below, (ii) the conditions under which the PPTA was deposited and under which the water cleaning step and the drying treatment were performed were changed so as to match the conditions shown in Table 2 below, and (iii) in the drying treatment, instead of the drying at the heating temperature R_{2b}, a porous film which had been obtained by the drying at the heating temperature R₂ₐ and on which the porous layer had been deposited was cut out to a size of 210 mm×297 mm, and a cut-out piece of the porous film on which the porous layer had been deposited was put into a thermostat bath and was subjected to a heat treatment (annealing) by heating at a temperature of 130° C. for 10 minutes. In Example 4, the porous layer was formed on only one surface of the porous film, that is, the steps of the second continuous coating to the second drying treatment were not performed. The single-sided laminated separator (4) was regarded as a separator (4).

### Comparative Example 1

A comparative single-sided laminated separator (1) was obtained in the same manner as Example 1 except that (i) the porous film was changed to a porous film having a thickness and a weight per unit area shown in Table 1 below, (ii) the conditions under which the PPTA was deposited and under which the water cleaning step and the drying treatment were performed were changed so as to match the conditions shown in Table 2 below, and (iii) in the drying treatment, the drying at the heating temperature R_{2b} was not performed. In Comparative Example 1, the porous layer was formed on only one surface of the porous film, that is, the steps of the second the continuous coating to the second drying treatment were not performed. The comparative single-sided laminated separator (1) was regarded as a comparative separator (1).

### Comparative Example 2

A comparative double-sided laminated separator (2) was obtained in the same manner as Example 1 except that the porous film was changed to a porous film having a thickness and a weight per unit area shown in Table 1 below, and that the conditions under which the PPTA was deposited and under which the water cleaning step and the drying treatment were performed were changed so as to match the conditions shown in Table 2 below. The comparative double-sided laminated separator (2) was regarded as a comparative separator (2).

TABLE 1
Physical property values of porous film and porous layer

| | | Example | Example | Example | Example | Comparative | Comparative |
|---|---|---|---|---|---|---|---|
| | | 1 | 2 | 3 | 4 | example 1 | example 2 |
| Porous | Thickness | 8.3 | 9.6 | 8.3 | 8.4 | 8.1 | 8.5 |
| film | [μm] | | | | | | |
| | Weight per | 4.7 | 5.0 | 4.7 | 4.7 | 4.4 | 4.6 |
| | unit area | | | | | | |
| | [g/m²] | | | | | | |
| Porous | Total | 3.3 | 4.4 | 2.9 | 2.0 | 2.5 | 1.6 |
| layer | thickness | | | | | | |
| | [μm] | | | | | | |
| | Total | 2.5 | 3.2 | 2.2 | 1.3 | 1.8 | 1.2 |
| | weight per | | | | | | |
| | unit area | | | | | | |
| | [g/m²] | | | | | | |

TABLE 2
Production conditions in porous layer formation (tensions/temperatures
at deposition, water cleaning, and heat treatment)

| | | | | | | Comp. | Comp. |
|---|---|---|---|---|---|---|---|
| | | Ex. 1 | Ex. 2 | Ex. 3 | Ex. 4 | Ex. 1 | Ex. 2 |
| Tension | Water | 0.092 | 0.092 | 0.104 | 0.092 | 0.121 | 0.121 |
| | cleaning | | | | | | |
| | MID | | | | | | |
| | [N/mm] | | | | | | |
| | Water | 0.116 | 0.116 | 0.092 | 0.116 | 0.121 | 0.121 |
| | cleaning | | | | | | |
| | OUT | | | | | | |
| | [N/mm] | | | | | | |
| | Drying | 0.127 | 0.116 | 0.139 | 0.127 | 0.127 | 0.127 |
| | treatment | | | | | | |
| | [N/mm] | | | | | | |
| Temperature | Deposition | 52 | 48 | 60 | 52 | 48 | 48 |
| | temperature | | | | | | |
| | [° C.] | | | | | | |
| | Heating | 80 | 80 | 75 | 80 | 80 | 80 |
| | temperature | | | | | | |
| | R₂ | | | | | | |
| | [° C.] | | | | | | |
| | Heating | 80 | 80 | 90 | 80 | 80 | 80 |
| | temperature | | | | | | |
| | R₂ₓ | | | | | | |
| | [° C.] | | | | | | |
| | Heating | 128 | 128 | 126 | — | — | 130 |
| | temperature | | | | | | |
| | R_{2b} | | | | | | |
| | [° C.] | | | | | | |
| | Annealing | — | — | — | 130 | — | — |
| | temperature | | | | | | |
| | [° C.] | | | | | | |

The following abbreviations are used in Table 2. Ex: Example; Comp. Ex.: Comparative Example

### Results

Table 3 below shows results of measuring, in the above-described manner, physical properties of the respective separators produced in Examples and Comparative Examples.

TABLE 3
Physical properties of separators

| | Example | Example | Example | Example | Comparative | Comparative |
|---|---|---|---|---|---|---|
| | 1 | 2 | 3 | 4 | Example 1 | Example 2 |
| Thickness | 11.6 | 14.0 | 11.2 | 10.4 | 10.6 | 10.1 |
| [μm] | | | | | | |
| Weight per | 7.2 | 8.2 | 6.9 | 6.0 | 6.2 | 5.8 |
| unit area | | | | | | |
| [g/m²] | | | | | | |
| Air | 194 | 208 | 189 | 134 | 155 | 120 |
| permeability | | | | | | |
| [sec/100 mL] | | | | | | |
| Thickness | 0.99 | −0.19 | −1.35 | −0.84 | −1.46 | −1.88 |
| change ratio | | | | | | |
| between | | | | | | |
| before and | | | | | | |
| after HS test | | | | | | |
| [%] | | | | | | |
| Withstand | 1.48 | 1.78 | 1.28 | 1.30 | 1.17 | 1.14 |
| voltage limit | | | | | | |
| after peeling | | | | | | |
| of porous layer | | | | | | |
| [kV] | | | | | | |

As shown in Table 3, for each of the separators (1) to (4) respectively described in Examples 1 to 4, the absolute value of the ratio of change in thickness between before and after the HS test was not more than 1.40%. In contrast, for each of the comparative separators (1) and (2) respectively described in Comparative Examples 1 and 2, the absolute value of the ratio of change in thickness between before and after the HS test was greater than 1.40%. Further, it was found that each of the separators (1) to (4) had a higher withstand voltage limit after the porous layer had been peeled off than the comparative separators (1) and (2) had, and that even if the porous layer had been partly peeled off after repeated charge-discharge cycles, each of the separators (1) to (4) retained a sufficient withstand voltage property.

In light of above, it was found that a separator in accordance with an embodiment of the present invention advantageously had an excellent withstand voltage property after repeated charge-discharge cycles when the absolute value of the ratio of change in thickness of the separator between before and after the HS test was not more than 1.40%,.

### INDUSTRIAL APPLICABILITY

A separator in accordance with an embodiment of the present invention has an excellent withstand voltage property after repeated charge-discharge cycles, and can be employed for manufacture of a nonaqueous electrolyte secondary battery having an excellent cycle characteristic.

1. A nonaqueous electrolyte secondary battery separator comprising:
a polyolefin porous film; and
a heat-resistant porous layer formed on one surface or both surfaces of the polyolefin porous film,
the heat-resistant porous layer containing a heat-resistant resin,
the nonaqueous electrolyte secondary battery separator having an absolute value of a ratio of change in thickness between before and after a heat-shock cycle test in a range of not more than 1.40%,
the ratio of change in thickness being defined by Formula (1) below,
ratio of change in thickness (%)={(D₀−D₁)/D₀}×100 (1)
where D₀ is a thickness (pm) of the nonaqueous electrolyte secondary battery separator before the heat-shock cycle test, and D₁ is a thickness (pm) of the nonaqueous electrolyte secondary battery separator after the heat-shock cycle test,
the heat-shock cycle test being performed under conditions in which: a high temperature is 85° C.; a low temperature is −40° C.; a maintenance time of the high temperature is 30 minutes; a maintenance time of the low temperature is 30 minutes; a temperature transition time between the high temperature and the low temperature is one minute; and number of cycles is 150 cycles.

2. The nonaqueous electrolyte secondary battery separator according to claim 1, wherein the heat-resistant porous layer is formed on each of the both surfaces of the polyolefin porous film.

3. The nonaqueous electrolyte secondary battery separator according to claim 1, wherein the heat-resistant resin is a nitrogen-containing aromatic resin.

4. The nonaqueous electrolyte secondary battery separator according to claim 3, wherein the nitrogen-containing aromatic resin is an aramid resin.

5. A nonaqueous electrolyte secondary battery member comprising:
a positive electrode,
the nonaqueous electrolyte secondary battery separator according to claim 1, and
a negative electrode,
the positive electrode, the nonaqueous electrolyte secondary battery separator, and the negative electrode being disposed in this order.

6. A nonaqueous electrolyte secondary battery comprising the nonaqueous electrolyte secondary battery separator according to claim 1.
